(19) United States
(12) Patent Application Publication
(10) Pub. No.: US 2011/0285653 A1
(43) Pub. Date: Nov. 24, 2011

(54) Information Processing Apparatus and Input Method

(76) Inventor: Satoshi Kojima, Hino-shi (JP)

(21) Appl. No.: 13/085,169

(22) Filed: Apr. 12, 2011

(30) Foreign Application Priority Data
May 21, 2010 (JP) 2010-117599

(51) Int. Cl. G06F 3/041

(52) U.S. Cl. 345/173

(57) ABSTRACT

According to one embodiment, a key select module selects one of a plurality of virtual keys as an input key candidate when the one of the virtual keys is touched, and changes the input key candidate to another virtual key in accordance with a movement of a touch position on a touch-screen display. The output module outputs code data associated with the virtual key which is selected as the input key candidate, when a touch state of the touch-screen display is released in a state in which the input key candidate is selected. The vibration control module causes the vibrator to vibrate with a first vibration pattern when the one of the virtual keys is touched, and causes the vibrator to vibrate with a second vibration pattern when the touch state of the touch-screen display is released in a state in which the input key candidate is selected.

### CROSS-REFERENCE TO RELATED APPLICATIONS

This application is based upon and claims the benefit of priority from Japanese Patent Application No. 2010-117599, filed May 21, 2010; the entire contents of which are incorporated herein by reference.

### FIELD

Embodiments described herein relate generally to an information processing apparatus and an input method for inputting code data by using virtual keys.

### BACKGROUND

In recent years, various types of information processing apparatuses, such as a portable personal computer and a PDA, have been developed. Most of these apparatuses have keyboards functioning as input devices.

In addition, recently, in order to support key input by a user, a system has been developed wherein a virtual keyboard is displayed on a touch-screen display such as a touch panel. In general, the virtual keyboard includes a plurality of keys (virtual keys). The user can input key data by touching, for example, with a fingertip, a target key of the keys displayed on the screen.

However, in the conventional virtual keyboard, since the screen is flat, it is difficult to give a key-press sensation to the user. As a method of improving the operational sensation of the virtual keyboard, there is known a method in which vibration is generated when a key on the screen has been touched. In addition, there is known a method in which vibration which is generated is varied in accordance with the intensity of pressing on the touch panel.

In the conventional methods using vibration, vibration is generated when the key on the screen is touched. The reason for this is that it is presupposed that at a time point when a key is touched, this key is finalized as an input key. However, the user may erroneously touch a key other than a target key. Thus, if a key is finalized as an input key when the key is touched, it is possible that en erroneous key input occurs.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view illustrating the external appearance of an information processing apparatus according to an embodiment.

FIG. 2 illustrates an example of a virtual keyboard which is displayed on a touch-screen display of the information processing apparatus of the embodiment.

FIG. 3 illustrates an example of the mode of use of the information processing apparatus of the embodiment.

FIG. 4 illustrates another example of the mode of use of the information processing apparatus of the embodiment.

FIG. 5 is an exemplary view for describing a key input operation which is executed by the information processing apparatus of the embodiment.

FIG. 6 is an exemplary view for describing a vibration stop process which is executed when a finger is touched to a boundary between two neighboring keys on the virtual keyboard of the information processing apparatus of the embodiment.

FIG. 7 is an exemplary view for describing another example of the key input operation which is executed by the information processing apparatus of the embodiment.

FIG. 8 is an exemplary block diagram illustrating the system configuration of the information processing apparatus of the embodiment.

FIG. 9 is an exemplary block diagram illustrating the structure of a key input program which is used in the information processing apparatus of the embodiment.

FIG. 10 is an exemplary flow chart illustrating an example of the procedure of a key input process which is executed by the information processing apparatus of the embodiment.

FIG. 11 is an exemplary flow chart illustrating another example of the procedure of the key input process which is executed by the information processing apparatus of the embodiment.

### DETAILED DESCRIPTION

Various embodiments will be described hereinafter with reference to the accompanying drawings.

In general, according to one embodiment, an information processing apparatus comprises a touch-screen display configured to display a plurality of virtual keys, a key select module, an output module, a vibrator, and a vibration control module. The key select module is configured to select one of the plurality of virtual keys as an input key candidate when the one of the plurality of virtual keys is touched, and to change the input key candidate to another virtual key in accordance with a movement of a touch position on the touch-screen display. The output module is configured to output code data associated with the virtual key which is selected as the input key candidate, when a touch state of the touch-screen display is released in a state in which the input key candidate is selected. The vibration control module is configured to cause the vibrator to vibrate with a first vibration pattern when the one of the plurality of virtual keys is touched, and to cause the vibrator to vibrate with a second vibration pattern when the touch state of the touch-screen display is released in a state in which the input key candidate is selected.

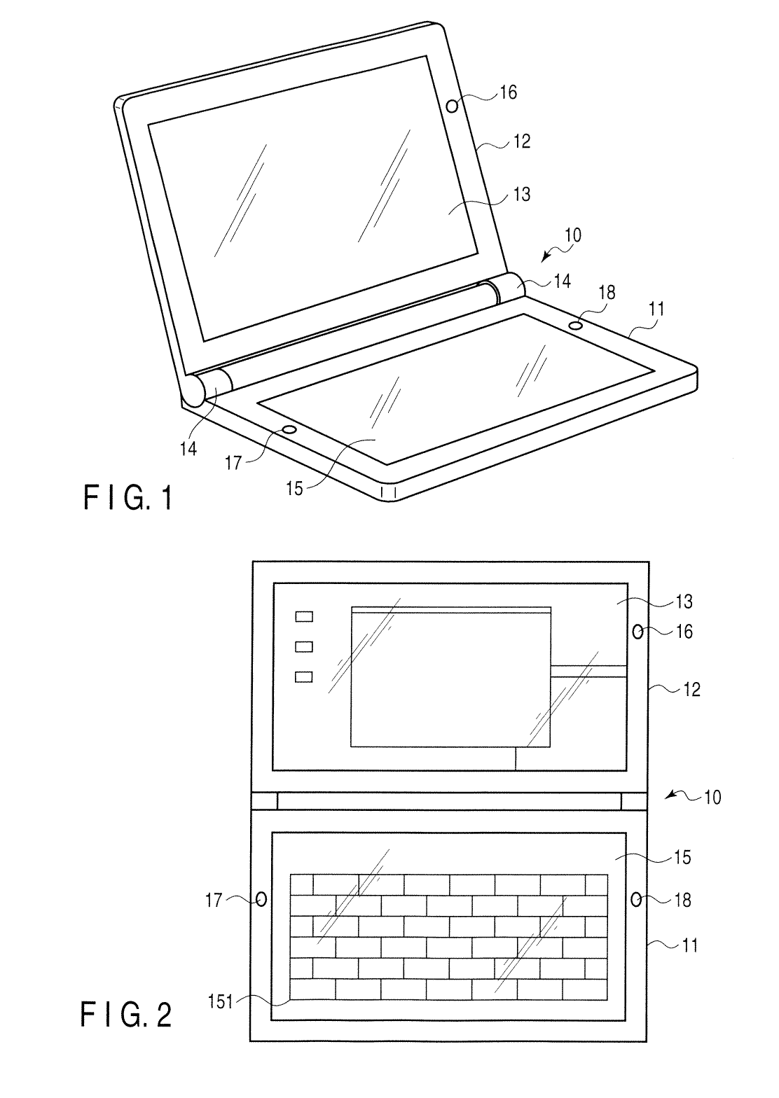

To begin with, referring to FIG. 1, the structure of an information processing apparatus according to an embodiment is described. This information processing apparatus is realized, for example, as a battery-powerable portable personal computer 10.

FIG. 1 is a perspective view showing the personal computer 10 in a state in which a display unit of the personal computer 10 is opened. The computer 10 comprises a computer main body 11 and a display unit 12. A display device comprising a liquid crystal display (LCD) 13 is built in a top surface of the display unit 12, and a display screen of the LCD 13 is disposed at a substantially central part of the display unit 12.

The display unit 12 has a thin box-shaped housing. The display unit 12 is rotatably attached to the computer main body 11 via a hinge portion 14. The hinge portion 14 is a coupling portion for coupling the display unit 12 to the computer main body 11. Specifically, a lower end portion of the display unit 12 is supported on a rear end portion of the computer main body 11 by the hinge portion 14. The display unit 12 is attached to the computer main body 11 such that the display unit 12 is rotatable, relative to the computer main body 11, between an open position where the top surface of the computer main body 11 is exposed and a closed position where the top surface of the computer main body 11 is covered by the display unit 12. A power button 16 for powering on or off the computer 10 is provided at a predetermined position on the top surface of the display unit 12, for example, on the right side of the LCD 13.

The computer main body 11 is a base unit having a thin box-shaped housing. A liquid crystal display (LCD) 15, which functions as a touch-screen display, is built in a top surface of the computer main body 11. A display screen of the LCD 15 is disposed at a substantially central part of the computer main body 11. A transparent touch panel is disposed on the top surface of the LCD 15. The touch-screen display is realized by the LCD 15 and the transparent touch panel. The touch-screen display can detect a touch position on the display screen, which is touched by a pen or a finger. The LCD 15 on the computer main body 11 is a display which is independent from the LCD 13 of the display unit 12. The LCDs 13 and 15 can be used as a multi-display for realizing a virtual screen environment. In this case, the virtual screen, which is managed by the operating system of the computer 10, comprises a first screen region which is displayed on the LCD 13, and a second screen region which is displayed on the LCD 15. An arbitrary application window, an arbitrary object, etc. can be displayed on the first screen region and the second screen region.

In the present embodiment, as shown in FIG. 2, the LCD 15 (touch-screen display) provided on the top surface of the main body 11 is used, for example, in order to present a virtual keyboard (also referred to as “software keyboard”) 151. The virtual keyboard 151 may be displayed, for example, on the entirety of the display screen of the LCD 15 in a full-screen mode. The virtual keyboard 151 comprises a plurality of virtual keys (e.g. a plurality of numeral keys, a plurality of alphabet keys, a plurality of arrow keys, a plurality of auxiliary keys, and a plurality of function keys) for inputting a plurality of key codes (code data). To be more specific, the virtual keyboard 151 comprises a plurality of buttons (software buttons) corresponding to the respective virtual keys.

On the other hand, the LCD 13 in the display unit 12 can be used as a main display for displaying various application windows, etc., as shown in FIG. 2. The user can input various code data (key code, character code, command, etc.) on the application window, etc. displayed on the LCD 13, by performing a touch operation on the virtual keyboard 151 displayed on the touch-screen display 15. In the meantime, the LCD 13 may also be realized as a touch-screen display.

Two button switches 17 and 18 are provided at predetermined positions on the top surface of the computer main body 11, for example, on both sides of the LCD 15. Arbitrary functions can be assigned to the button switches 17 and 18. For example, the button switch 17 may be used as a button switch for starting a key input program which is an application program for controlling a key input operation using the virtual keyboard 151. When the button switch 17 has been pressed by the user, the key input program is started. The key input program displays the virtual keyboard 151 on the touch-screen display 15.

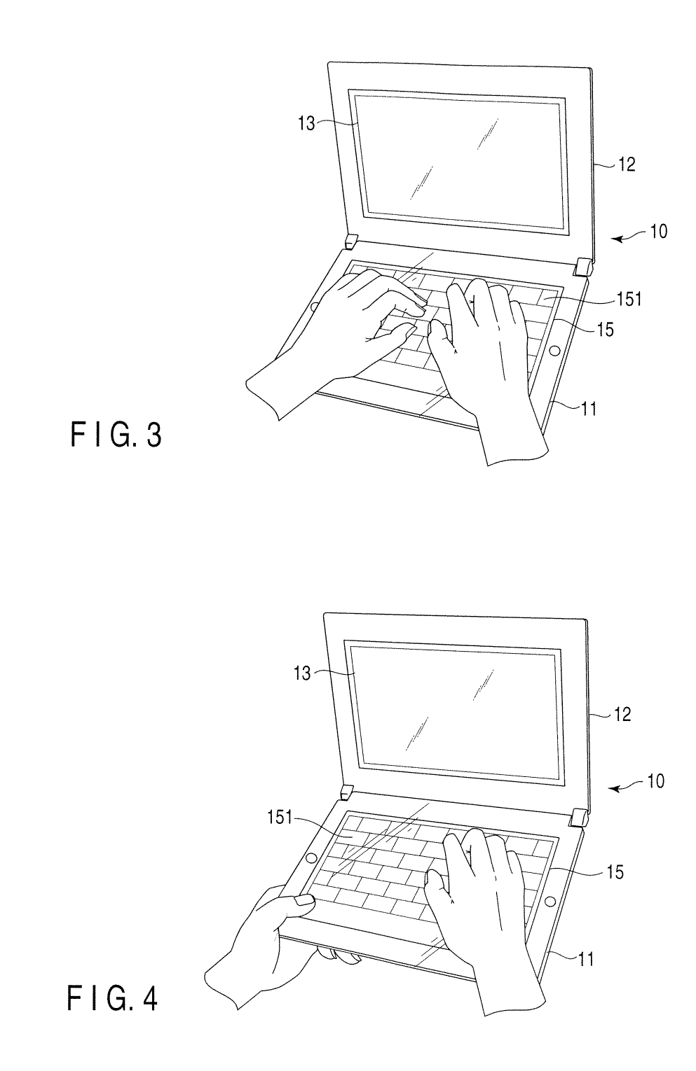

FIG. 3 and FIG. 4 show examples of the mode of use of the computer 10. FIG. 3 illustrates a state in which the user manipulates the virtual keyboard 151 on the touch-screen display 15 by both hands. FIG. 4 illustrates a state in which the user manipulates the virtual keyboard 151 on the touch-screen display 15 by the right hand, while holding the main body 11 of the computer 10 by the left hand.

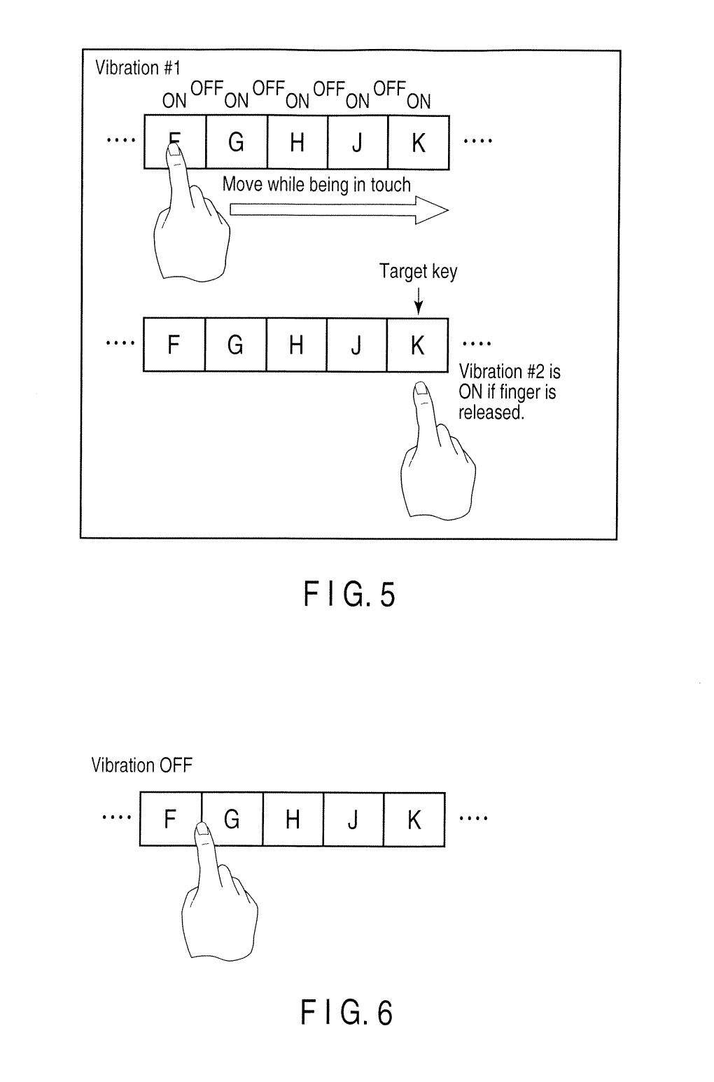

Next, referring to FIG. 5, a description is given of a key input operation which is executed by the computer 10. When one of the virtual keys on the touch-screen display 15 has been touched, the key input program selects the touched virtual key as an input key candidate, from among the virtual keys. Further, the key input program changes the input key candidate to another virtual key, in accordance with the movement of the touch position on the touch-screen display 15. In this description, the movement of the touch position means that the position of the user's finger on the touch-screen display 15 varies in the state in which the touch-screen display 15 is being touched, that is, the position of the user's finger is slid in the state in which the touch-screen display 15 is being touched. For example, the case is now assumed in which a virtual key “F” is first touched, and then the touch position is moved from the virtual key “F” toward a virtual key “K”. In this case, the key input program first selects the virtual key “F” as an input key candidate. Then, if the touch position is moved onto a virtual key “G”, the key input program changes the input key candidate from the virtual key “F” to the virtual key “G”, and selects the virtual key “G” as a new input key candidate. Similarly, if the touch position is moved onto the virtual key “K”, for example, the key input program changes the input key candidate to the virtual key “K”, and selects the virtual key “K” as a new input key candidate. If the touch state of the touch-screen display 15 is released in the state in which the input key candidate is selected, that is, if the user's finger is released from the virtual key that is currently selected as the input key candidate, the key input program finalizes the virtual key, which is currently selected as the input key candidate, as the input key, and outputs code data, which is associated with the virtual key that is currently selected as the input key candidate, to a program such as an application program or the operating system.

In this manner, the input key is finalized, not at the time when the virtual key is touched, but at the time when the touch state of the touch-screen display is released.

Furthermore, the key input program has a function of generating two different kinds of vibrations in accordance with the manipulation of the virtual key, thereby to improve the operational sensation of virtual keys. For example, when one of the virtual keys has been touched, the key input program causes a vibrator in the computer 10 to vibrate with a first vibration pattern (vibration #1). The user can sense vibration, for example, by the finger which is in contact with the virtual key. This vibration (vibration #1) can inform the user that the finger is positioned on an inputtable key. Then, if the touch state of the touch-screen display 15 is released in the state in which the input key candidate is selected, the key input program causes the vibrator in the computer 10 to vibrate with a second vibration pattern (vibration #2) which is different from the first vibration pattern. The user can sense vibration, for example, by the palm which is in contact with the top surface of the main body 11 of the computer 10, or by the hand holding the main body 11. This vibration (vibration #2) can inform the user that the input key has been finalized. The vibrator may be realized by, for instance, a motor.

The key input program can control ON/OFF of the vibration #1 in accordance with the movement of the touch position. Assume now the case in which the touch position has been moved from the virtual key “F” to the virtual key “K”. The key input program controls the vibrator in an order of vibration ON, vibration OFF, vibration ON, vibration OFF, vibration ON, vibration OFF, . . . , in accordance with the movement of the touch position. In other words, the vibrator vibrates with the first vibration pattern, only when the touch position is at a position where a key input is enabled. When the touch position is at a position where a key input is disabled, for example, when the fingertip is positioned on a boundary between neighboring keys, as shown in FIG. 6, the vibrator does not vibrate. Thereby, it is possible to correctly notify that the finger is on an inputtable key.

As described above, when the finger is in contact with any one of the virtual keys on the virtual keyboard 151, that is, when the user gropes for a target key while sliding the fingertip, the vibrator vibrates with the first vibration pattern. When the finger is released from the touch-screen display 15 in the state in which a certain virtual key is selected, the virtual key which is currently selected is finalized as the input key, and the vibrator vibrates with the second vibration pattern. At this time, the finger is released from the virtual key, but, in usual cases, the palm or the other hand, which is not used for key input, is in contact with the main body 11. Thus, the user can sense a variation in vibration at the time of finalizing the key, by the palm or by the other hand which is not used for key input.

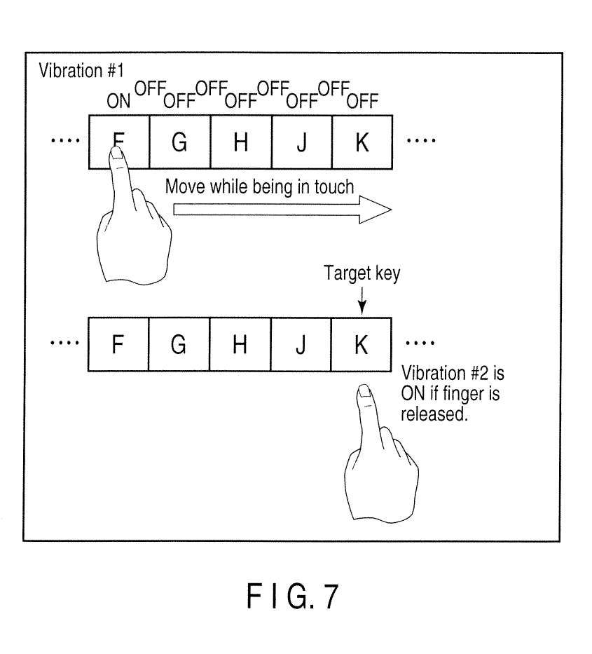

Next, referring to FIG. 7, a description is given of another example of the key input operation which is executed by the computer 10.

In the example of FIG. 7, when a virtual key is first touched, the vibrator vibrates with the first vibration pattern. If the touch position is moved, the vibration of the vibrator is stopped. The case is now assumed in which the virtual key “F” is first touched, and then the touch position is moved from the virtual key “F” toward the virtual key “K” by the user sliding the position of the fingertip. When the virtual key “F” has been first touched, the key input program selects the virtual key “F” as an input key candidate, and causes the vibrator to vibrate with the first vibration pattern. If the touch position is moved onto a boundary between the virtual key “F” and virtual key “G”, the key input program stops the vibration of the vibrator. If the touch position is moved onto the virtual key “G”, the key input program selects the virtual key “G” as a new input key candidate. Similarly, if the touch position is moved onto the virtual key “K”, the key input program selects the virtual key “K” as a new input key candidate. If the touch state of the touch-screen display 15 is released in the state in which the input key candidate is selected, that is, if the user's finger is released from the currently selected virtual key, the key input program finalizes the currently selected virtual key as the input key, and outputs code data, which is associated with the currently selected virtual key, to a program such as an application program or the operating system. In addition, in order to inform the user that the input key has been finalized, the key input program causes the vibrator to vibrate with the second vibration pattern.

The key input program can selectively execute the vibration control of FIG. 5 or the vibration control of FIG. 7, in accordance with the mode designated by the user.

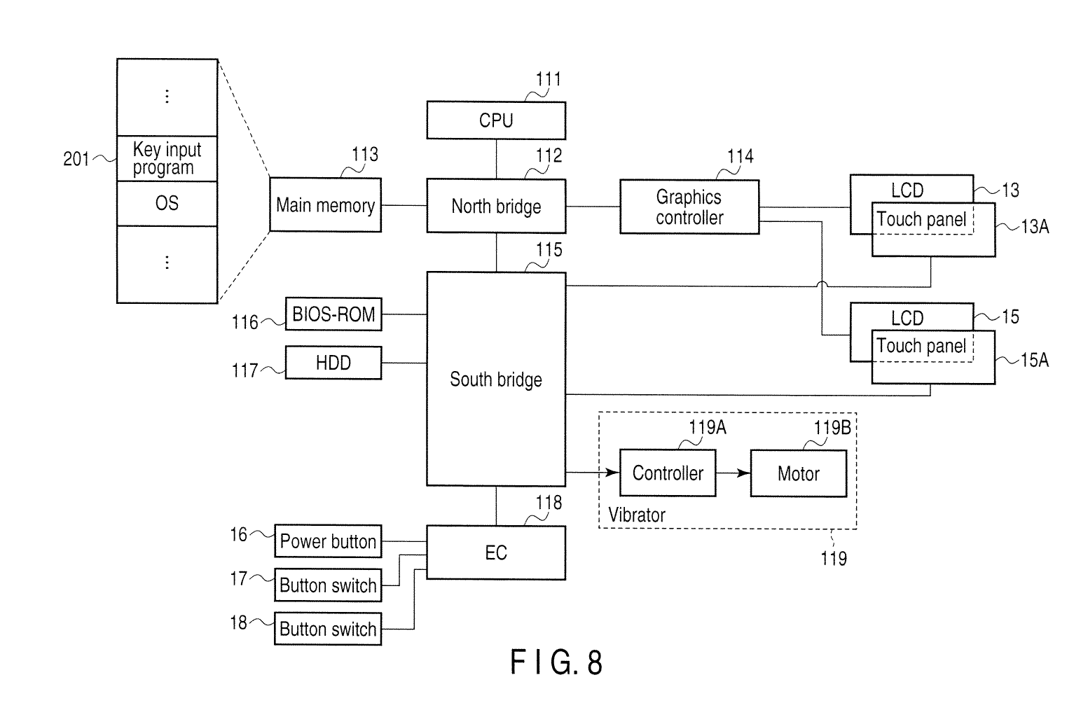

Next, referring to FIG. 8, the system configuration of the computer 10 is described. The case is now assumed in which both LCDs 13 and 15 are realized as touch-screen displays.

The computer 10 comprises a CPU 111, a north bridge 112, a main memory 113, a graphics controller 114, a south bridge 115, a BIOS-ROM 116, a hard disk drive (HDD) 117, an embedded controller 118 and a vibrator 119.

The CPU 111 is a processor which is provided in order to control the operation of the computer 10. The CPU 111 executes an operating system (OS) and various application programs, which are loaded from the HDD 117 into the main memory 113. The application programs include a key input program 201. The key input program 201 displays the virtual keyboard 151 on the touch-screen display 15, and generates code data in accordance with the user's touch operation on the virtual keyboard 151. The generated code data (e.g. a key code corresponding to a touched virtual key) is delivered, for example, to an active application via the operating system (OS). Besides, the CPU 111 executes a system BIOS (Basic Input/Output System) which is stored in the BIOS-ROM 116. The system BIOS is a program for hardware control.

The north bridge 112 is a bridge device which connects a local bus of the CPU 111 and the south bridge 115. The north bridge 112 includes a memory controller which access-controls the main memory 113. The graphics controller 114 is a display controller which controls the two LCDs 13 and 15 which are used as a display monitor of the computer 10. The graphics controller 114 executes a display process (graphics arithmetic process) for rendering display data on a video memory (VRAM), based on a rendering request which is received from the CPU 111 via the north bridge 112. A memory area for storing display data corresponding to a screen image which is displayed on the LCD 13 and a memory area for storing display data corresponding to a screen image which is displayed on the LCD 15 are allocated to the video memory. A transparent touch panel 13A is disposed on the LCD 13. Similarly, a transparent touch panel 15A is disposed on the LCD 15. Each of the touch panels 13A and 15A is configured to detect a touch position on the touch panel (touch-screen display) by using, for example, a resistive method or a capacitive method. As each of the touch panel 13A, 15A, use may be made of a multi-touch panel which can detect a plurality of touch positions at the same time.

The south bridge 115 incorporates an IDE (Integrated Drive Electronics) controller and a Serial ATA controller for controlling the HDD 121. The embedded controller (EC) 118 has a function of powering on/off the computer 10 in accordance with the operation of the power button switch 16 by the user.

The vibrator 119 is a device which is configured to vibrate. The vibrator 119 may be composed of, for example, a controller 119A and a motor 119B. The vibrator 119 is caused to vibrate by the rotation of the motor 119B, and the main body 11 can be vibrated by this vibration.

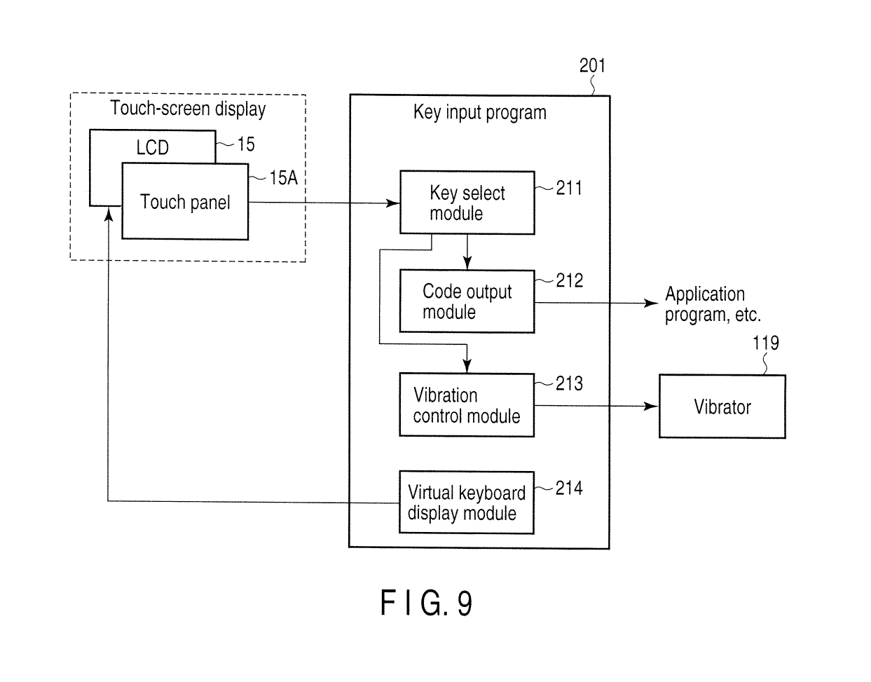

Next, referring to FIG. 9, the structure of the key input program 201 is described.

The key input program 201 receives touch position detection information from the touch panel 15A, and selects, based on the touch position detection information, a virtual key which has been touched by the user, from among the virtual keys in the virtual keyboard 151. The touch position detection information includes coordinate data indicative of a touch position on the touch-panel display (LCD 15 and touch panel 15A) which has been touched by an external member (e.g. the user's finger, or a pen).

The key input program 201 comprises, as function-executing modules, a key select module 211, a code output module 212, a vibration control module 213 and a virtual keyboard display module 214. When one of the plural virtual keys included in the virtual keyboard 151 has been touched, the key select module 211 selects, from along the virtual keys, the touched virtual key as an input key candidate. In addition, the key select module 211 changes the input key candidate to another virtual key in accordance with the movement of the touch position on the touch-screen display. For example, when the touch position has been moved from one virtual key to another virtual key on the virtual keyboard 151 in the state in which the touch-screen display is touched, the key select module 211 changes the input key candidate to this another virtual key and selects this another virtual key as a new input key candidate. In this manner, the key select module 211 can change the input key candidate in accordance with the movement of the touch position. Since an input key is not finalized while the user's finger is in contact with the touch-screen display, the user can position the finger on a target virtual key while sliding the position of the finger on the touch-screen display.

Triggered by the release of the touch state of the touch-screen display in the state in which the input key candidate is selected, the code output module 212 finalizes the current input key candidate as the input key, and outputs a key code which is associated with the virtual key that is currently selected as the input key candidate. This key code is delivered to a program such as an application program or the operating system.

The vibration control module 213 controls the vibrator 119 and causes the vibrator 119 to vibrate. For example, the vibration control module 213 causes the vibrator 119 to vibrate with the first vibration pattern, when a virtual key has been selected as an input key candidate by the key select module 211. In addition, for example, when the current input key candidate has been finalized as the input key, that is, when the touch state of the touch-screen display has been released in the state in which the input key candidate is selected, the vibration control module 213 causes the vibrator 119 to vibrate with the second vibration pattern. As the vibration pattern, use may be made of the cycle of vibration or the number of times of vibration. In addition, the vibration control module 213 stops the vibration of the vibrator 119 when the touch position has been moved onto a boundary between virtual keys by the movement of the touch position after one of the virtual keys was touched. Furthermore, the vibration control module 213 causes the vibrator 119 to vibrate with the first vibration pattern when the touch position has been moved from the boundary between the virtual keys onto another virtual key by the movement of the touch position.

The virtual keyboard display module 214 displays the virtual keyboard 151 on the display screen of the LCD 15. As described above, the virtual keyboard 151 includes a plurality of virtual keys for inputting a plurality of key codes (code data). Besides, the virtual keyboard display module 214 has a function of varying the size of the virtual keyboard 151 which is displayed on the display screen of the LCD 15.

On the virtual keyboard 151, a plurality of keys are arranged with a relatively small pitch. In addition, the virtual keyboard 151 is unable to give a click sensation to the user. Thus, during the type input period of the virtual keyboard 151, it is possible that not only a target virtual key but also a boundary between the target virtual key and its neighboring virtual key is touched by the user's finger. In the present embodiment, the vibrator 119 vibrates only when the touch position is on any one of the virtual keys. When the touch position is on a key boundary at which an erroneous input may possibly occur, the vibrator does not vibrate. Thus, it is possible to inform the user that the finger is on the inputtable key. Further, the input key is finalized, not at the time when the virtual key is touched, but at the time when the touch state of the touch-screen display 15 is released. Therefore, the user can grope for a target key while sliding the fingertip, and can position the fingertip on the target key.

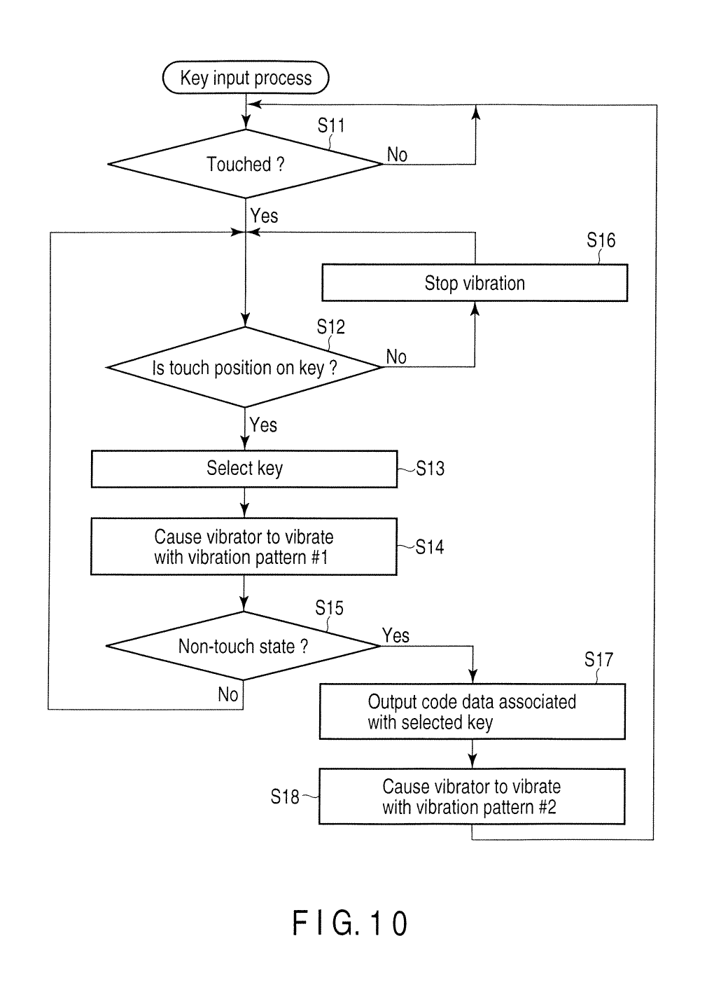

Next, referring to a flow chart of FIG. 10, a description is given of an example of the procedure of a key input process which is executed by the key input program 201.

When the key input program 201 is started, the key input program 201 displays the virtual keyboard 151 on the LCD 15 (touch-screen display) on the main body 11. The key input program 201 receives touch position detection information from the touch panel 15A, and can select, based on the touch position detection information, whether the touch-screen display has been touched, and can determine a touch position on the touch-screen display. If the touch-screen display has been touched (YES in step S11), the key input program 201 determines whether the touch position is on any one of the virtual keys in the virtual keyboard 151 (step S12). If the touch position is on any one of the virtual keys, that is, if any one of the virtual keys has been touched (YES in step S12), the key input program 201 selects the touched virtual key as an input key candidate (step S13). By sending a first driving signal to the vibrator 119, the key input program 201 causes the vibrator 119 to vibrate with the first vibration pattern (step S14).

While the touch-screen display is in the touched state, the key input program 201 monitors the touch position. If the touch position is moved to a position at which a key input is disabled, such as a boundary between keys (NO in step S12), the key input program 201 stops the vibration of the vibrator 119 (step S16). On the other hand, if the touch position is moved onto another virtual key (YES in step S12), the key input program 201 selects this another virtual key as a new input key candidate (step S13).

If the user's finger is released from the touch-screen display and thus the touch state of the touch-screen display is released (YES in step S15), the key input program 201 finalizes the currently selected virtual key as the input key, and outputs code data, which is associated with the currently selected virtual key, to a program such as an application program or the operating system (step S17). In addition, by sending a second driving signal to the vibrator 119, the key input program 201 causes the vibrator 119 to vibrate with the second vibration pattern (step S18).

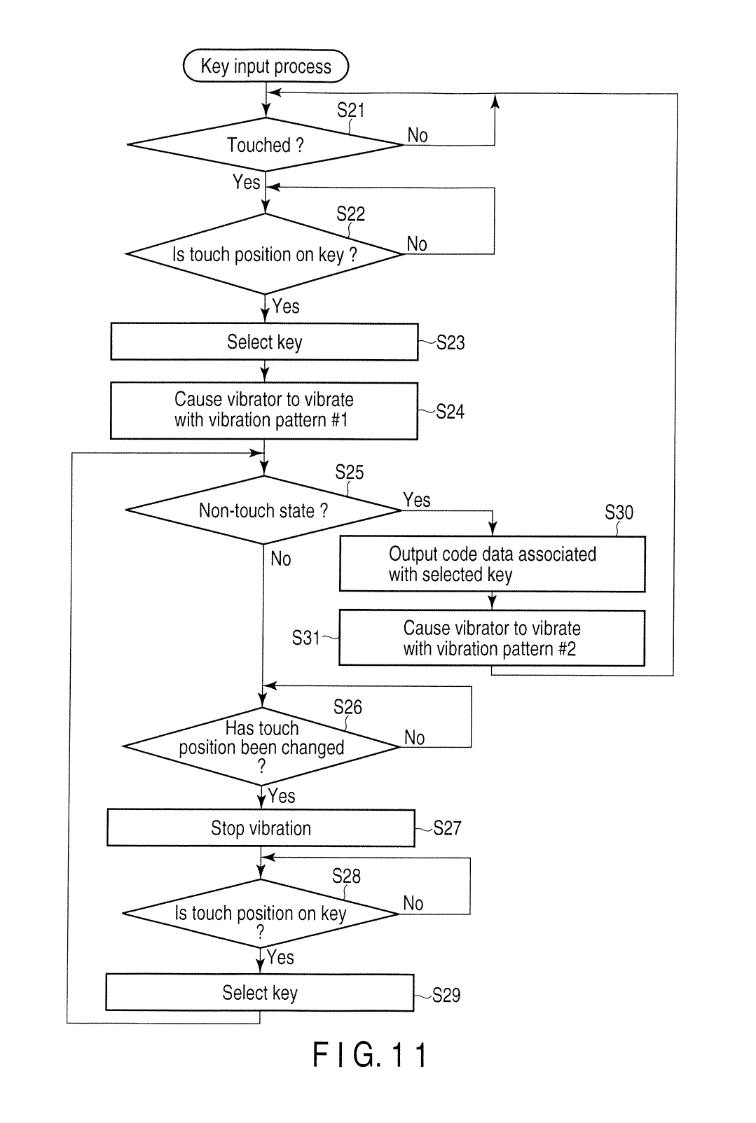

Next, referring to a flow chart of FIG. 11, a description is given of another example of the procedure of the key input process which is executed by the key input program 201. The flow chart of FIG. 11 corresponds to the vibration control, as illustrated in FIG. 7, in which the vibrator is caused to vibrate with the first vibration pattern when the virtual key is first touched, and the vibration of the vibrator is stopped when the touch position is then moved.

If the touch-screen display has been touched (YES in step S21), the key input program 201 determines whether the touch position is on any one of the virtual keys in the virtual keyboard 151 (step S22). If the touch position is on any one of the virtual keys, that is, if any one of the virtual keys has been touched (YES in step S22), the key input program 201 selects the touched virtual key as an input key candidate (step S23). By sending a first driving signal to the vibrator 119, the key input program 201 causes the vibrator 119 to vibrate with the first vibration pattern (step S24).

While the touch-screen display is in the touched state, the key input program 201 monitors the touch position. If the touch position is moved to a position at which a key input is disabled, such as a boundary between keys, or moved onto another virtual key (YES in step S26), the key input program 201 stops the vibration of the vibrator 119 (step S27). Then, the key input program 201 determines whether the touch position after the movement is on a virtual key (step S28). If the touch position after the movement is on a virtual key (YES in step S28), the key input program 201 selects this virtual key as a new input key candidate (step S29).

If the user's finger is released from the touch-screen display and thus the touch state of the touch-screen display is released (YES in step S25), the key input program 201 finalizes the currently selected virtual key as the input key, and outputs code data, which is associated with the currently selected virtual key, to a program such as an application program or the operating system (step S30). In addition, by sending a second driving signal to the vibrator 119, the key input program 201 causes the vibrator 119 to vibrate with the second vibration pattern (step S31).

As has been described above, according to the present embodiment, when one of the virtual keys has been touched, the touched virtual key is selected as the input key candidate, and the vibrator 119 vibrates with the first pattern. The input key candidate is changed to another virtual key in accordance with the movement of the touch position. When the touch state of the touch-screen display has been released, the code data associated with the virtual key, which is currently selected as the input key candidate, is output, and the vibrator 119 vibrates with the second vibration pattern. Thereby, the user can recognize, by the first vibration, whether the current touch position is on the virtual key or not. In addition, even after the user once touched a virtual key other than a target key, the user can move the finger onto the target key by sliding the finger. Moreover, the user can recognize, by the second vibration, that the input key has been finalized. Therefore, the possibility of an erroneous input of key data can be reduced, and the operational sensation of virtual keys can be improved.

The above-described virtual keys may be buttons such as dial keys. In addition, the computer 10 of the embodiment includes the main body 11 and the display unit 12. It is not necessary to provide almost all the components, which constitute the system of the computer 10, within the main body 11. For example, some or almost all these components may be provided within the display unit 12. In this sense, it can be said that the main body 11 and the display unit 11 are substantially equivalent units. Therefore, the main body 11 can be thought to be the display unit, and the display unit 12 can be thought to be the main body.

The computer 10 of the embodiment includes the display (LCD 13) in addition to the touch-screen display. However, since the touch-screen display can display at the same time the virtual keyboard, an application window, etc., the computer 10 may be configured to include only the touch-screen display, without including the display (LCD 13).

Besides, the key input function of the embodiment is realized by a computer program. Thus, the same advantageous effects as with the present embodiment can easily be obtained simply by installing the computer program into a computer including a touch-screen display through a computer-readable storage medium which stores the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a touch-screen display configured to display a plurality of virtual keys;
a key select module configured to select one of the plurality of virtual keys as an input key candidate when the one of the plurality of virtual keys is touched, and to change the input key candidate to another virtual key in accordance with a movement of a touch position on the touch-screen display;
an output module configured to output code data associated with the virtual key which is selected as the input key candidate, when a touch state of the touch-screen display is released in a state in which the input key candidate is selected;
a vibrator; and
a vibration control module configured to cause the vibrator to vibrate with a first vibration pattern when the one of the plurality of virtual keys is touched, and to cause the vibrator to vibrate with a second vibration pattern when the touch state of the touch-screen display is released in a state in which the input key candidate is selected.

2. The information processing apparatus of claim 1, wherein the vibration control module is configured to stop the vibration of the vibrator when the touch position is moved onto a boundary between virtual keys by the movement of the touch position after the one of the plurality of virtual keys was touched.

3. The information processing apparatus of claim 2, wherein the vibration control module is configured to cause the vibrator to vibrate with the first vibration pattern, when the touch position is moved from the boundary between the virtual keys onto another virtual key by the movement of the touch position.

4. An input method of inputting code data corresponding to a touched key by using a touch-screen display of an information processing apparatus, the method comprising:
displaying on the touch-screen display a plurality of virtual keys for inputting code data;
selecting one of the plurality of virtual keys as an input key candidate when the one of the plurality of virtual keys is touched;
changing the input key candidate to another virtual key in accordance with a movement of a touch position on the touch-screen display;
outputting code data associated with the virtual key which is selected as the input key candidate, when a touch state of the touch-screen display is released in a state in which the input key candidate is selected;
causing a vibrator in the information processing apparatus to vibrate with a first vibration pattern when the one of the plurality of virtual keys is touched; and
causing the vibrator to vibrate with a second vibration pattern when the touch state of the touch-screen display is released in a state in which the input key candidate is selected.

5. The input method of claim 4, further comprising stopping the vibration of the vibrator when the touch position is moved onto a boundary between virtual keys by the movement of the touch position after the one of the plurality of virtual keys is touched.

6. The input method of claim 5, further comprising causing the vibrator to vibrate with the first vibration pattern, when the touch position is moved from the boundary between the virtual keys onto another virtual key by the movement of the touch position.

7. A program for inputting code data corresponding to a touched key by using a touch-screen display of a computer, the program being configured to cause the computer to:
display on the touch-screen display a plurality of virtual keys for inputting code data;
select one of the plurality of virtual keys as an input key candidate when the one of the plurality of virtual keys is touched;
change the input key candidate to another virtual key in accordance with a movement of a touch position on the touch-screen display;
output code data associated with the virtual key which is selected as the input key candidate, when a touch state of the touch-screen display is released in a state in which the input key candidate is selected;
cause a vibrator in the computer to vibrate with a first vibration pattern when the one of the plurality of virtual keys is touched; and
cause the vibrator to vibrate with a second vibration pattern when the touch state of the touch-screen display is released in a state in which the input key candidate is selected.
